(19) United States
(12) Patent Application Publication
(10) Pub. No.: US 2021/0288558 A1
(43) Pub. Date: Sep. 16, 2021

(54) STATOR UNIT OF ROTARY ELECTRIC MACHINE AND METHOD FOR MANUFACTURING STATOR UNIT OF ROTARY ELECTRIC MACHINE

(71) Applicant: HONDA MOTOR CO., LTD., Tokyo (JP)

(72) Inventor: Atsushi NISHIDA, Saitama (JP)

(73) Assignee: HONDA MOTOR CO., LTD., Tokyo (JP)

(21) Appl. No.: 17/198,647

(22) Filed: Mar. 11, 2021

(30) Foreign Application Priority Data
Mar. 16, 2020 (JP) 2020-045570

(51) Int. Cl. H02K 11/25; H02K 3/48; H02K 1/16; H02K 15/06; H01C 7/00

(52) U.S. Cl. CPC H02K 11/25; H02K 3/48; H01C 7/008; H02K 15/062; H02K 1/16

(57) ABSTRACT

A stator unit of a rotary electric machine includes a stator including a stator core and a coil, and a thermistor fixed to the coil. The stator core includes a plurality of teeth and a plurality of slots. The coil includes a plurality of segment conductors inserted into each of the plurality of slots. The segment conductor includes a leg portion and an oblique portion. The thermistor is fixed to the coil by being sandwiched between the oblique portion of a predetermined segment conductor and the oblique portion of a segment conductor which is adjacent to the predetermined segment conductor in a peripheral direction.

### CROSS-REFERENCE TO RELATED APPLICATIONS

This application is based upon and claims the benefit of priority from prior Japanese patent application No. 2020-045570, filed on Mar. 16, 2020, the entire contents of which are incorporated herein by reference.

### TECHNICAL FIELD

The present invention relates to a stator unit of a rotary electric machine mounted on an electric vehicle or the like, and a method for manufacturing a stator unit of a rotary electric machine.

### BACKGROUND ART

In the related art, a rotary electric machine such as an electric motor and a generator is mounted on an electric vehicle such as a hybrid vehicle, a battery drive vehicle, a fuel cell vehicle. As a rotary electric machine mounted on an electric vehicle or the like, there is known a rotary electric machine including a stator having a substantially annular stator core in which a plurality of slot portions are formed on an inner peripheral surface thereof and a coil inserted into the plurality of slot portions of the stator core.

In such a rotary electric machine, the coil in particular generates heat in association with driving. When the rotary electric machine becomes excessively hot due to the heat generation, the output performance may be deteriorated. Therefore, for example, JP-A-2003-32964 discloses a rotary electric machine in which a temperature sensor for detecting temperature of a coil is attached to the coil so as to monitor the temperature of the coil.

The rotary electric machine described in JP-A-2003-32964 includes the temperature sensor, a holding member that holds the temperature sensor and has elasticity, and a fixing member such as a bracket fixed to an accommodating case or the like of the rotary electric machine, in which the temperature sensor is fixed to the fixing member via the holding member that has elasticity. The temperature sensor is pressed against the coil by an elastic force of the holding member, so that the temperature of the coil can be detected.

However, in the stator unit of JP-A-2003-32964, since the stator unit is required to be arranged in the vicinity of the fixing member, an arrangement position of the stator unit is restricted. Further, there is a problem that the accuracy of detecting the temperature of the coil by the temperature sensor is lowered due to a variation in a pressing force applied to the temperature sensor against the coil due to the elastic force and dimensional accuracy of the holding member that holds and presses the temperature sensor against the coil.

### SUMMARY

The present invention provides a stator unit of a rotary electric machine which has an improved degree of freedom in layout and can accurately measure temperature of a coil with a simple configuration, and a method for manufacturing a stator unit of a rotary electric machine.

According to an aspect of the present invention, there is provided a stator unit of a rotary electric machine, the stator unit including a stator including a stator core having a substantially annular shape and a coil assembled to the stator core, and a thermistor fixed to the coil. The stator core includes a plurality of teeth protruding toward an inner side in a radial direction at predetermined intervals along a peripheral direction and a plurality of slots formed between adjacent teeth. The coil includes a plurality of segment conductors inserted into each of the plurality of slots. The segment conductor includes a leg portion arranged inside the slot and extending substantially linearly in an axial direction and an oblique portion protruding toward an outer side in the axial direction of one end surface of the stator core in the axial direction from one end portion of the leg portion in the axial direction, and extending obliquely in the peripheral direction. The thermistor is fixed to the coil by being sandwiched between the oblique portion of a predetermined segment conductor and the oblique portion of a segment conductor which is adjacent to the predetermined segment conductor in the peripheral direction.

According to another aspect of the present invention, there is provided a method for manufacturing a stator unit of a rotary electric machine. The stator unit includes a stator including a stator core having a substantially annular shape and a coil assembled to the stator core, and a thermistor fixed to the coil. The stator core includes a plurality of teeth protruding toward an inner side in a radial direction at predetermined intervals along a peripheral direction, and a plurality of slots formed between adjacent teeth. The coil includes a plurality of segment conductors inserted into each of the plurality of slots. The method for manufacturing a stator unit of a rotary electric machine includes a segment conductor insertion step of inserting the plurality of segment conductors into the slot such that protruding portions are formed to protrude toward an outer side in an axial direction from one end surface of the stator core in the axial direction, a thermistor arrangement step of arranging the thermistor between the protruding portion of a predetermined segment conductor and the protruding portion of a segment conductor which is adjacent to the predetermined segment conductor in the peripheral direction, and an oblique portion forming step of forming an oblique portion by the protruding portion of the segment conductor oblique in the peripheral direction. In the oblique portion forming step, the thermistor is fixed to the coil by being sandwiched between the oblique portion of the predetermined segment conductor and the oblique portion of the segment conductor which is adjacent to the predetermined segment conductor in the peripheral direction.

According to the present invention, a degree of freedom in layout of a stator unit is improved, and temperature of a coil can be accurately measured with a simple configuration.

### BRIEF DESCRIPTION OF DRAWINGS

FIG. 1 is a view of a stator unit of a rotary electric machine according to an embodiment of the present invention as viewed from an outer side in a radial direction.

FIG. 2 is a sectional view of the stator unit of a rotary electric machine in FIG. 1 as viewed from an axial direction.

FIGS. 3A and 3B are perspective views of a segment conductor in the stator unit of a rotary electric machine in FIG. 1.

FIG. 4 is a perspective view of periphery of a thermistor in the stator unit of a rotary electric machine in FIG. 1 as viewed from the outer side in the radial direction.

FIGS. 5A and 5B are diagrams for illustrating a method for manufacturing the stator unit of a rotary electric machine, in which periphery of the thermistor in the stator unit of a rotary electric machine is viewed from the outer side in the radial direction.

### DESCRIPTION OF EMBODIMENTS

Hereinafter, a stator unit of a rotary electric machine according to an embodiment of the present invention will be described with reference to the accompanying drawings.

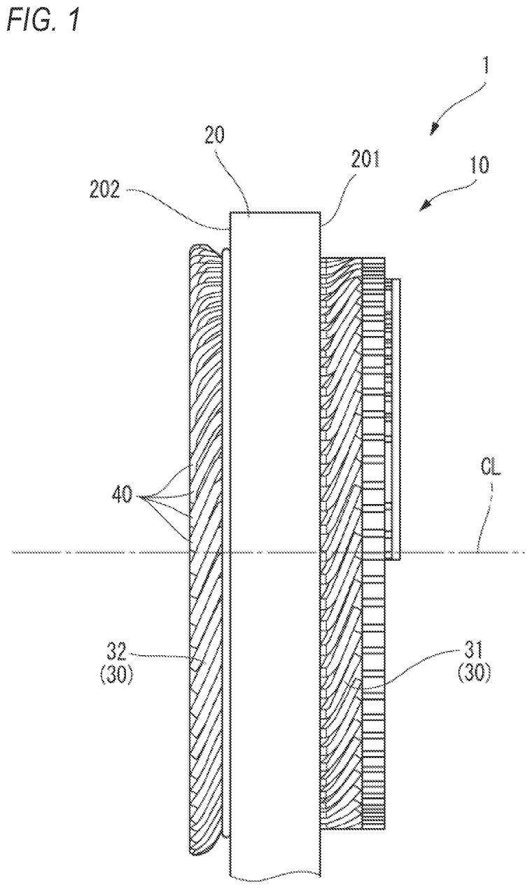

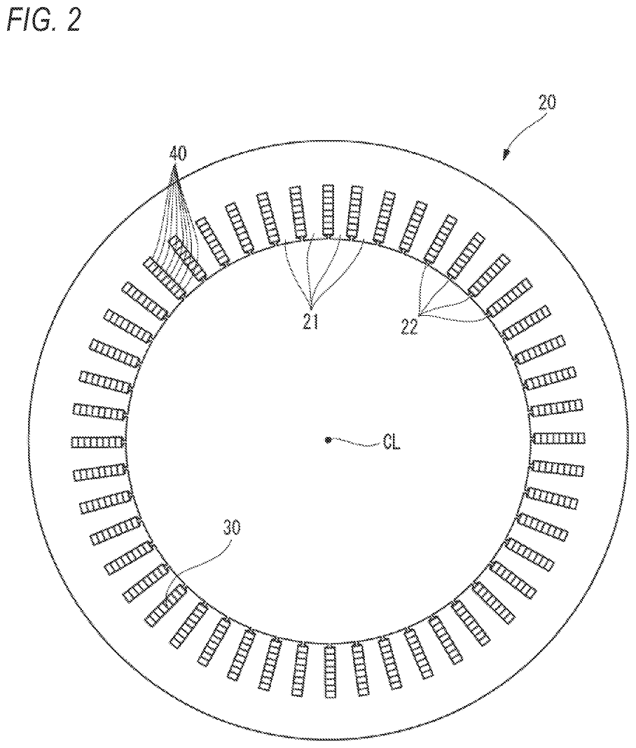

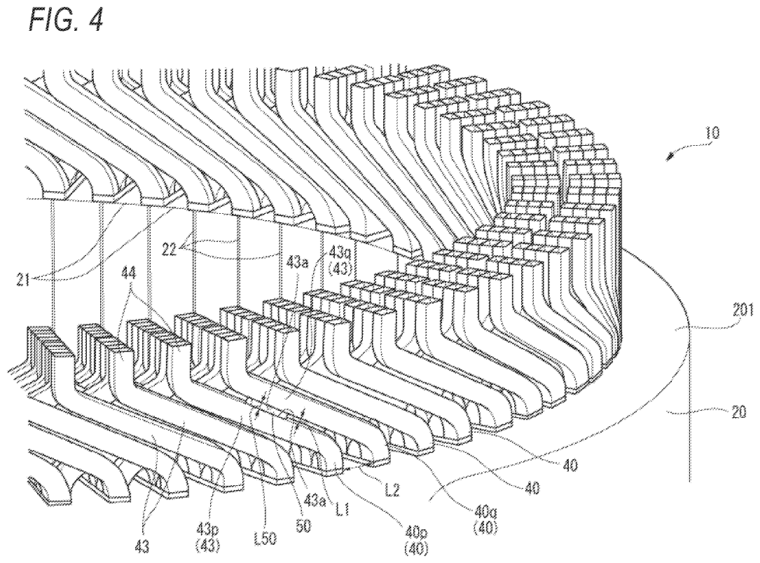

As shown in FIGS. 1 and 2, a stator unit 1 of a rotary electric machine according to the present embodiment includes a stator 10 having a substantially annular stator core 20 and a coil 30 assembled to the stator core 20, and a thermistor 50 (see FIG. 4) fixed to the coil 30.

In the present specification and the like, for the sake of simplicity and clarity, an axial direction, a radial direction, and a peripheral direction refer to directions with reference to a central axis CL of the stator 10 and the stator core 20. Further, an inner side in the axial direction refers to a central side of the stator 10 in the axial direction, and an outer side in the axial direction refers to a side away from the center of the stator 10 in the axial direction.

The stator core 20 has a substantially annular shape, and includes a plurality of teeth 21 protruding toward an inner side in the radial direction at predetermined intervals along the peripheral direction, and a plurality of slots 22 which are spaces between adjacent teeth 21 in the peripheral direction. In the present embodiment, the stator core 20 has 48 teeth 21, and 48 slots 22 are formed. The stator core 20 is formed as a laminated core formed by laminating a plurality of electromagnetic steel plates having a predetermined thickness in the axial direction. The stator core 20 has a first end surface 201 and a second end surface 202 in the axial direction.

The coil 30 is assembled to the stator core 20, and is formed with a first coil end portion 31 protruding toward the outer side in the axial direction from the first end surface 201 of the stator core 20, and a second coil end portion 32 protruding toward the outer side in the axial direction from the second end surface 202 of the stator core 20.

The coil 30 includes a plurality of segment conductors 40 inserted into each of the 48 slots 22.

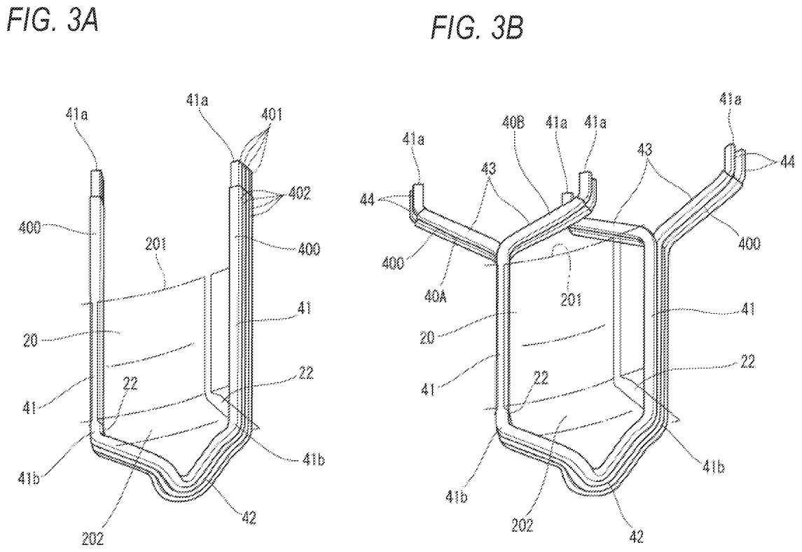

As shown in FIGS. 3A and 3B, in the segment conductor 40, an insulating coating portion 402 is provided on a conductor portion 401 having a substantially rectangular cross section. The segment conductor 40 includes a pair of leg portions 41 extending in parallel with each other and each having a first end portion 41a and a second end portion 41b, and a curved portion 42 connecting the second end portions 41b of the pair of leg portions 41. The segment conductor 40 has a substantially U shape. The segment conductor 40 is arranged such that the pair of leg portions 41 are respectively inserted into different slots 22 of the stator core 20, the curved portion 42 protrudes toward the outer side in the axial direction from the second end surface 202 of the stator core 20, the first end portions 41a of the pair of leg portions 41 protrude toward the outer side in the axial direction from the first end surface 201 of the stator core 20, and a protruding portion 400 is formed to protrude toward the outer side in the axial direction from the first end surface 201 of the stator core 20.

A front end part of the protruding portion 400 is held by a jig (not shown) and rotated relative to the stator core 20 in the peripheral direction while approaching the stator core 20 in the axial direction, so that the protruding portion 400 is bent in the peripheral direction of the stator core 20. As a result, the protruding portion 400 has a shape including an oblique portion 43 that bends and extends toward a direction approaching each other or away from each other in the peripheral direction of the stator core 20, and a front end portion 44 that extends toward the outer side in the axial direction of the stator core 20 from a front end of the oblique portions 43, which is the front end part of the protruding portion 400 held by the jig.

The segment conductors 40 formed in such a manner include a lap winding segment conductor 40A obtained by the oblique portion 43 bending and extending toward the direction approaching each other in the peripheral direction of the stator core 20, and a wave winding segment conductor 40B obtained by the oblique portion 43 bending and extending toward the direction away from each other in the peripheral direction of the stator core 20.

As shown in FIG. 4, in the present embodiment, in each slot 22 of the stator core 20, eight layers of leg portions 41 of the segment conductors 40 are inserted in a line in the radial direction.

When viewed from the first end surface 201 side of the stator core 20, of the eight layers of leg portions 41 inserted into each slot 22 of the stator core 20, oblique portions 43 of the leg portions 41 arranged in a first layer, a third layer, a fifth layer, and a seventh layer counting from the inner side in the radial direction are oblique counterclockwise in the peripheral direction, and oblique portions 43 of the leg portions 41 arranged in a second layer, a fourth layer, a sixth layer, and an eighth layer are oblique clockwise in the peripheral direction. Therefore, the eight layers of leg portions 41 inserted into each slot 22 of the stator core 20 are inserted side by side in the radial direction so that oblique directions of the oblique portions 43 alternates between clockwise and counterclockwise.

The front end portion 44 extending from the front end of the oblique portion 43 which is oblique counterclockwise of the leg portion 41 arranged in the first layer is joined to and conducts with the front end portion 44 extending from the front end of the oblique portion 43 which is oblique clockwise of the leg portion 41 arranged in the second layer of the slot 22 that is separated by a predetermined number of slots counterclockwise. Similarly, the front end portion 44 extending from the front end of the oblique portion 43 which is oblique counterclockwise of the leg portion 41 arranged in the third layer, the fifth layer, or the seventh layer is joined to and conducts with the front end portion 44 extending from the front end of the oblique portion 43 which is oblique clockwise of the leg portion 41 arranged in the fourth layer, the sixth layer, or the eighth layer of the slot 22 that is separated by the predetermined number of slots counterclockwise.

In this way, the coil 30 is formed by conducting the plurality of segment conductors 40 inserted into each of the 48 slots 22 and winding the teeth 21. The oblique portion 43 and the front end portion 44 of each segment conductor 40 form the first coil end portion 31 of the coil 30, and the curved portion 42 of each segment conductor 40 forms the second coil end portion 32 of the coil 30.

(Thermistor)

The thermistor 50 is fixed to the coil 30 and detects temperature of the coil 30. In the related art, the thermistor is fixed to the coil by being pressed against an outer peripheral portion of the coil by, for example, a pressing force of a leaf spring. For this reason, it is necessary to provide a holding member such as a leaf spring that presses the thermistor against the outer peripheral portion of the coil in an accommodating case or the like of the rotary electric machine, and therefore, an arrangement position of the stator unit is restricted. Further, there is a problem that the accuracy of detecting the temperature of the coil by the thermistor is lowered due to a variation in a pressing force and dimensional accuracy of the holding member such as a leaf spring that presses the thermistor against the outer peripheral portion of the coil.

In the present embodiment, the thermistor 50 is fixed to the coil 30 by being sandwiched between an oblique portion 43p of a segment conductor 40p arranged in the outermost layer (in the present embodiment, the eighth layer from the inner side in the radial direction) of a predetermined slot 22 and an oblique portion 43q of a segment conductor 40q which is adjacent to the segment conductor 40p in the peripheral direction. The thermistor 50 is fixed to the coil 30 by being sandwiched between a sandwiching portion 43a of the oblique portion 43p of the segment conductor 40p and a sandwiching portion 43a the oblique portion 43q of the segment conductor 40q.

Therefore, a fixing member for the thermistor 50 is unnecessary, and the thermistor 50 can be arranged inside the first coil end portion 31 of the coil 30. As a result, a degree of freedom in layout of the stator unit 1 is improved, and temperature of the coil 30 can be accurately measured with a simple configuration.

A distance between oblique portions L1, that is, a distance between the oblique portion 43p of the segment conductor 40p and the oblique portion 43q of the segment conductor 40q that sandwich the thermistor 50 is shorter than a distance between base end portions L2, that is, a distance between the segment conductor 40p and the segment conductor 40q in the first end surface 201 of the stator core 20. Further, a length L50 of the thermistor 50 in a direction sandwiched between the oblique portion 43p of the segment conductor 40p and the oblique portion 43q of the segment conductor 40q is equal to or greater than the distance between oblique portions L1 and less than the distance between base end portions L2.

Accordingly, the length L50 of the thermistor 50 is less than the distance between base end portions L2, so that the thermistor 50 can be easily arranged between the segment conductor 40p and the segment conductor 40q before the oblique portions 43 are formed. Further, the length L50 of the thermistor 50 is equal to or greater than the distance between oblique portions L1, so that the thermistor 50 can be firmly fixed between the oblique portion 43p of the segment conductor 40p and the oblique portion 43q of the segment conductor 40q due to the formation of the oblique portions 43.

(Method for Manufacturing Stator Unit)

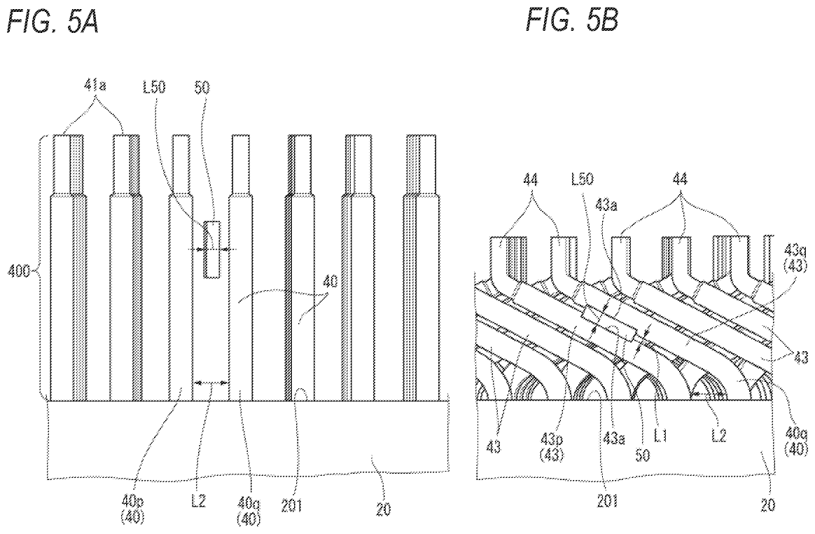

Next, a method for manufacturing the stator unit 1 will be described with reference to FIGS. 5A and 5B.

The method for manufacturing the stator unit 1 according to the present embodiment includes a segment conductor insertion step, a thermistor arrangement step, and an oblique portion forming step.

First, as shown in FIG. 5A, in the segment conductor insertion step, a plurality of segment conductors 40 are inserted into the slot 22 such that the first end portions 41a of the leg portions 41 protrude toward the outer side in the axial direction from the first end surface 201 of the stator core 20, and the protruding portions 400 are formed to protrude toward the outer side in the axial direction from the first end surface 201 of the stator core 20.

Next, in the thermistor arrangement step, the thermistor 50 is arranged between the segment conductor 40p arranged in the outermost layer (in the present embodiment, the eighth layer from the inner side in the radial direction) of a predetermined slot 22 and the segment conductor 40q which is adjacent to the segment conductor 40p in the peripheral direction.

At this time, the length L50 of the thermistor 50 in the direction sandwiched between the oblique portion 43p of the segment conductor 40p and the oblique portion 43q of the segment conductor 40q is the distance between base end portions L2, that is, the distance between the segment conductor 40p and the segment conductor 40q in the first end surface 201 of the stator core 20.

Therefore, in the thermistor arrangement step, the thermistor 50 can be easily arranged between the segment conductor 40p and the segment conductor 40q.

Next, as shown in FIG. 5B, in the oblique portion forming step, the front end part of the protruding portion 400 is held by a jig (not shown) and rotated relative to the stator core 20 in the peripheral direction while approaching the stator core 20 in the axial direction, so that the protruding portion 400 is bent in the peripheral direction of the stator core 20. As a result, the oblique portions 43 that bend and extend toward a direction approaching each other or away from each other in the peripheral direction of the stator core 20, and front end portions 44 that extend toward the outer side in the axial direction of the stator core 20 from front ends of the oblique portions 43, which are the front end parts of the protruding portions 400 held by the jig are formed.

In the oblique portion forming step, the protruding portions 400 are bent in the peripheral direction of the stator core 20 to form the oblique portions 43, so that the thermistor 50 arranged between the segment conductor 40p and the segment conductor 40q is sandwiched by the oblique portion 43p of the segment conductor 40p and the oblique portion 43q of the segment conductor 40q, and is fixed to the coil 30. The thermistor 50 is fixed to the coil 30 by being sandwiched between the sandwiching portion 43a of the oblique portion 43p of the segment conductor 40p and the sandwiching portion 43a of the oblique portion 43q of the segment conductor 40q.

As a result, a fixing member for the thermistor 50 is unnecessary, and the thermistor 50 can be easily arranged inside the first coil end portion 31 of the coil 30. Therefore, the stator unit 1 of the rotary electric machine capable of accurately measuring the temperature of the coil 30 can be easily manufactured.

At this time, in the oblique portion forming step, the oblique portions 43 are formed such that the distance between oblique portions L1, that is, the distance between the oblique portion 43p of the segment conductor 40p and the oblique portion 43q of the segment conductor 40q that sandwich the thermistor 50 is shorter than the distance between base end portions L2, that is, the distance between the segment conductor 40p and the segment conductor 40q in the first end surface 201 of the stator core 20.

As a result, the thermistor 50 can be reliably and easily fixed to the coil 30.

Further, the length L50 of the thermistor 50 in the direction sandwiched between the oblique portion 43p of the segment conductor 40p and the oblique portion 43q of the segment conductor 40q is equal to or larger than the distance between oblique portions L1 between the oblique portion 43p of the segment conductor 40p and the oblique portion 43q of the segment conductor 40q that sandwich the thermistor 50.

Therefore, in the oblique portion forming step, the thermistor 50 is firmly sandwiched between the oblique portion 43p of the segment conductor 40p and the oblique portion 43q of the segment conductor 40q, so that the thermistor 50 can be firmly fixed to the coil 30.

Although the embodiment of the present invention has been described above, the present invention is not limited thereto and modifications, improvements, or the like can be made as appropriate.

For example, the method for manufacturing the stator unit 1 may further include a resin coating step of coating the thermistor 50, and the sandwiching portion 43a of the oblique portion 43p of the segment conductor 40p and the sandwiching portion 43a of the oblique portion 43q of the segment conductor 40q that sandwich the thermistor 50 with a resin. In the stator unit 1, the thermistor 50, and the sandwiching portion 43a of the oblique portion 43p of the segment conductor 40p and the sandwiching portion 43a of the oblique portion 43q of the segment conductor 40q that sandwich the thermistor 50 may be coated with a resin. In the resin coating step, the thermistor 50 and the sandwiching portions 43a are coated with a resin by using, for example, powder coating or varnish. As for the coating with a resin, not only the thermistor 50 and the sandwiching portions 43a but also the entire first coil end portion 31 may be coated with the resin.

As a result, the thermistor 50, and the sandwiching portion 43a of the oblique portion 43p of the segment conductor 40p and the sandwiching portion 43a of the oblique portion 43q of the segment conductor 40q that sandwich the thermistor 50 are coated with a resin, so that the thermistor 50 can be more firmly fixed to the coil 30.

Further, for example, in the present embodiment, in order to describe the arrangement of the thermistor 50 in an easy-to-understand manner, the thermistor 50 is fixed to the coil 30 by being sandwiched between the oblique portion 43p of the segment conductor 40p arranged in the outermost layer (in the present embodiment, the eighth layer from the inner side in the radial direction) of a predetermined slot 22 and the oblique portion 43q of the segment conductor 40q which is adjacent to the predetermined segment conductor 40p in the peripheral direction, and the thermistor 50 may be fixed to the coil 30 by being sandwiched between the oblique portion 43p of the segment conductor 40p arranged in any one of the first layer to the eighth layer from the inner side in the radial direction of a predetermined slot 22 and the oblique portion 43q of the segment conductor 40q. When the rotary electric machine is driven, the first coil end portion 31 of the coil 30 tends to have the highest temperature at the center portion in the radial direction, and therefore, the thermistor 50 is preferably fixed to the coil 30 by being sandwiched between the oblique portion 43p of the segment conductor 40p arranged in the center portion in the radial direction (for example, in the present embodiment, the fourth layer or the fifth layer from the inner side in the radial direction) of a predetermined slot 22 and the oblique portion 43q of the segment conductor 40q. As a result, temperature of a portion of the first coil end portion 31 that tends to be the hottest can be detected.

At least the following matters are described in the present specification. Although corresponding constituent elements or the like in the above embodiment are shown in parentheses, the present invention is not limited thereto.

(1) A stator unit (stator unit 1) of a rotary electric machine, the stator unit including:

a stator (stator 10) including a stator core (stator core 20) having a substantially annular shape, and a coil (coil 30) assembled to the stator core; and

a thermistor (thermistor 50) fixed to the coil,

wherein the stator core includes a plurality of teeth (teeth 21) protruding toward an inner side in a radial direction at predetermined intervals along a peripheral direction, and a plurality of slots (slots 22) formed between adjacent teeth,

wherein the coil includes a plurality of segment conductors (segment conductor 40) inserted into each of the plurality of slots,

wherein the segment conductor includes:
a leg portion (leg portion 41) arranged inside the slot and extending substantially linearly in an axial direction; and
an oblique portion (oblique portion 43) protruding toward an outer side in the axial direction of one end surface of the stator core in the axial direction (first end surface 201) from one end portion of the leg portion in the axial direction, and extending obliquely in the peripheral direction, and

wherein the thermistor is fixed to the coil by being sandwiched between the oblique portion of a predetermined segment conductor and the oblique portion of a segment conductor which is adjacent to the predetermined segment conductor in the peripheral direction.

According to (1), the thermistor is fixed to the coil by being sandwiched between the oblique portion of a predetermined segment conductor and the oblique portion of a segment conductor which is adjacent to the predetermined segment conductor in the peripheral direction, so that a fixing member for the thermistor is unnecessary, and the thermistor can be arranged inside the coil end portion of the coil. As a result, a degree of freedom in layout of the rotary electric machine is improved, and temperature of the coil can be accurately measured with a simple configuration.

(2) The stator unit of a rotary electric machine according to (1),

wherein a distance between oblique portions (distance between oblique portions L1) which is a distance between the oblique portions of the one segment conductor and the other segment conductor that sandwich the thermistor is shorter than a distance between base end portions (distance between base end portions L2) which is a distance between the one segment conductor and the other segment conductor in the one end surface of the stator core in the axial direction, and wherein a length (length L50) of the thermistor in a direction sandwiched by the oblique portions of the segment conductors is equal to or greater than the distance between oblique portions and less than the distance between base end portions.

According to (2), the distance between oblique portions is shorter than the distance between base end portions, and the length of the thermistor in the direction sandwiched by the oblique portions of the segment conductors is equal to or greater than the distance between oblique portions and less than the distance between base end portions, so that the thermistor can be easily arranged between the predetermined segment conductor and the segment conductor adjacent to the predetermined segment conductor in the peripheral direction, and the thermistor can be firmly fixed.

(3) The stator unit of a rotary electric machine according to (0) or (2),

wherein the thermistor and sandwiching portions of the oblique portions of the segment conductors that sandwich the thermistor are coated with a resin.

According to (3), the thermistor and the sandwiching portions of the oblique portions of the segment conductors that sandwich the thermistor are coated with a resin, so that the thermistor can be more firmly fixed to the coil.

(4) A method for manufacturing a stator unit (stator unit 1) of a rotary electric machine,

the stator unit including:

a stator (stator 10) including a stator core (stator core 20) having a substantially annular shape, and a coil (coil 30) assembled to the stator core; and

a thermistor (thermistor 50) fixed to the coil,

wherein the stator core includes a plurality of teeth (teeth 21) protruding toward an inner side in a radial direction at predetermined intervals along a peripheral direction, and a plurality of slots (slots 22) formed between adjacent teeth, and

wherein the coil includes a plurality of segment conductors (segment conductor 40) inserted into each of the plurality of slots,

the method for manufacturing a stator unit of a rotary electric machine comprising:

a segment conductor insertion step of inserting the plurality of segment conductors into the slot such that protruding portions (protruding portion 400) are formed to protrude toward an outer side in an axial direction from one end surface of the stator core in the axial direction (first end surface 201);

a thermistor arrangement step of arranging the thermistor between the protruding portion of a predetermined segment conductor and the protruding portion of a segment conductor which is adjacent to the predetermined segment conductor in the peripheral direction; and

an oblique portion forming step of forming an oblique portion (oblique portion 43) by the protruding portion of the segment conductor oblique in the peripheral direction,

wherein in the oblique portion forming step, the thermistor is fixed to the coil by being sandwiched between the oblique portion of the predetermined segment conductor and the oblique portion of the segment conductor which is adjacent to the predetermined segment conductor in the peripheral direction.

According to (4), the thermistor is arranged between the protruding portion of the predetermined segment conductor and the protruding portion of the segment conductor which is adjacent to the predetermined segment conductor in the peripheral direction in the thermistor arrangement step, and then the oblique portion is formed by the protruding portion of the segment conductor oblique in the peripheral direction in the oblique portion forming step, so that the thermistor is fixed to the coil by being sandwiched between the oblique portion of the predetermined segment conductor and the oblique portion of the segment conductor which is adjacent to the predetermined segment conductor in the peripheral direction. Therefore, a fixing member for the thermistor is unnecessary, and the thermistor can be easily arranged inside the coil end portion of the coil. Therefore, the stator unit of the rotary electric machine capable of accurately measuring the temperature of the coil can be easily manufactured.

(5) The method for manufacturing a stator unit of a rotary electric machine according to (4),

wherein in the oblique portion forming step,

the oblique portion is formed such that a distance between oblique portions (distance between oblique portions L1) which is a distance between the oblique portions of the one segment conductor and the other segment conductor that sandwich the thermistor is shorter than a distance between base end portions (distance between base end portions L2) which is a distance between the one segment conductor and the other segment conductor in the one end surface of the stator core in the axial direction, and

wherein a length (length L50) of the thermistor in a direction sandwiched by the oblique portions of the segment conductors is equal to or greater than the distance between oblique portions and less than the distance between base end portions.

According to (5), in the oblique portion forming step, the oblique portion is formed such that the distance between oblique portions is shorter than the distance between base end portions, so that the thermistor can be reliably and easily fixed to the coil.

Further, the length of the thermistor in the direction sandwiched by the oblique portions of the segment conductors is less than the distance between base end portions, so that in the thermistor arrangement step, the thermistor can be easily arranged between the protruding portion of the predetermined segment conductor and the protruding portion of the segment conductor which is adjacent to the predetermined segment conductor in the peripheral direction.

Further, the length of the thermistor in the direction sandwiched by the oblique portions of the segment conductors is equal to or greater than the distance between oblique portions, so that in the oblique portion forming step, the thermistor can be firmly sandwiched between the oblique portion of the predetermined segment conductor and the oblique portion of the segment conductor which is adjacent to the predetermined segment conductor in the peripheral direction. As a result, the thermistor can be firmly fixed to the coil.

(6) The method for manufacturing a stator unit of a rotary electric machine according to (4) or (5), further comprising:

a resin coating step of coating the thermistor and sandwiching portions of the oblique portions of the segment conductors that sandwich the thermistor with a resin.

According to (6), in the resin coating step, the thermistor and the sandwiching portions of the oblique portions of the segment conductors that sandwich the thermistor are coated with a resin, so that the thermistor can be more firmly fixed to the coil 30.

What is claimed is:

1. A stator unit of a rotary electric machine, the stator unit comprising:
a stator including a stator core having a substantially annular shape, and a coil assembled to the stator core; and
a thermistor fixed to the coil,
wherein the stator core includes a plurality of teeth protruding toward an inner side in a radial direction at predetermined intervals along a peripheral direction, and a plurality of slots formed between adjacent teeth,
wherein the coil includes a plurality of segment conductors inserted into each of the plurality of slots,
wherein the segment conductor includes:
a leg portion arranged inside the slot and extending substantially linearly in an axial direction; and
an oblique portion protruding toward an outer side in the axial direction of one end surface of the stator core in the axial direction from one end portion of the leg portion in the axial direction, and extending obliquely in the peripheral direction, and
wherein the thermistor is fixed to the coil by being sandwiched between the oblique portion of a predetermined segment conductor and the oblique portion of a segment conductor which is adjacent to the predetermined segment conductor in the peripheral direction.

2. The stator unit of a rotary electric machine according to claim 1,
wherein a distance between oblique portions which is a distance between the oblique portions of the one segment conductor and the other segment conductor that sandwich the thermistor is shorter than a distance between base end portions which is a distance between the one segment conductor and the other segment conductor in the one end surface of the stator core in the axial direction, and
wherein a length of the thermistor in a direction sandwiched by the oblique portions of the segment conductors is equal to or greater than the distance between oblique portions and less than the distance between base end portions.

3. The stator unit of a rotary electric machine according to claim 1,
wherein the thermistor and sandwiching portions of the oblique portions of the segment conductors that sandwich the thermistor are coated with a resin.

4. A method for manufacturing a stator unit of a rotary electric machine,
the stator unit including:
a stator including a stator core having a substantially annular shape, and a coil assembled to the stator core; and
a thermistor fixed to the coil,
wherein the stator core includes a plurality of teeth protruding toward an inner side in a radial direction at predetermined intervals along a peripheral direction, and a plurality of slots formed between adjacent teeth, and
wherein the coil includes a plurality of segment conductors inserted into each of the plurality of slots,
the method for manufacturing a stator unit of a rotary electric machine comprising:
a segment conductor insertion step of inserting the plurality of segment conductors into the slot such that protruding portions are formed to protrude toward an outer side in an axial direction from one end surface of the stator core in the axial direction;
a thermistor arrangement step of arranging the thermistor between the protruding portion of a predetermined segment conductor and the protruding portion of a segment conductor which is adjacent to the predetermined segment conductor in the peripheral direction; and
an oblique portion forming step of forming an oblique portion by the protruding portion of the segment conductor oblique in the peripheral direction,
wherein in the oblique portion forming step, the thermistor is fixed to the coil by being sandwiched between the oblique portion of the predetermined segment conductor and the oblique portion of the segment conductor which is adjacent to the predetermined segment conductor in the peripheral direction.

5. The method for manufacturing a stator unit of a rotary electric machine according to claim 4,
wherein in the oblique portion forming step,
the oblique portion is formed such that a distance between oblique portions which is a distance between the oblique portions of the one segment conductor and the other segment conductor that sandwich the thermistor is shorter than a distance between base end portions which is a distance between the one segment conductor and the other segment conductor in the one end surface of the stator core in the axial direction, and
wherein a length of the thermistor in a direction sandwiched by the oblique portions of the segment conductors is equal to or greater than the distance between oblique portions and less than the distance between base end portions.

6. The method for manufacturing a stator unit of a rotary electric machine according to claim 4, further comprising:
a resin coating step of coating the thermistor and sandwiching portions of the oblique portions of the segment conductors that sandwich the thermistor with a resin.
